(19) United States
(12) Patent Application Publication
(10) Pub. No.: US 2025/0286829 A1
(43) Pub. Date: Sep. 11, 2025

(54) PRIORITIZING TRAFFIC FOR OPTIMAL PERFORMANCE

(71) Applicant: T-MOBILE INNOVATIONS LLC, Overland Park, KS (US)

(72) Inventor: Phi Hoang NGUYEN, Bellevue, WA (US)

(21) Appl. No.: 18/601,612

(22) Filed: Mar. 11, 2024

(51) Int. Cl. H04L 47/6275; H04L 47/2425

(52) U.S. Cl. CPC H04L 47/6275; H04L 47/2433

(57) ABSTRACT

Methods and systems are provided for improving quality of service by prioritizing at the transaction level. The method may begin with receiving, at a gateway, an inbound or outbound transaction from a user device. The gateway may access and identify transaction identifiers associated with each transaction. A large language model may categorize each type of transaction. Upon categorization of the transaction, a generative artificial intelligence may prioritize the transaction. Based on the priority level of the transaction, the transaction may be ranked against a plurality of transactions received at the gateway. Using the transaction ranking, the highest ranked transaction may be communicated first, then all other transactions received at the router may be communicated according to its transaction ranking, wherein the next highest ranked transaction is communicated and so on.

### BACKGROUND

Quality-of-service (QOS) in telecommunications refers to the overall performance of a telephony or computer network, particularly the performance seen by the users of the network. Network activity gradually increased over time until the 2020 pandemic, which ignited a surge in network traffic within households. This heightened network activity underscored the challenge of network congestion, a challenge that is compounded by the uniform application of QoS across all devices. A similar scenario unfolds in business environments, where network congestion is a pervasive issue due to a higher user volume compared to home settings. Most network routers support a first come, first served approach to help user transactions flow though network routers and exit the local network to a destination. Although, following a first come, first served approach does not appreciate the urgency warranted by some transactions. To combat this issue, contemporary in-home routers facilitate QoS adjustments and assign higher priority routing to specific devices. However, a limitation arises when a device is uniformly granted elevated priority across all transactions, potentially unnecessarily prioritizing certain transactions.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

According to aspects herein, methods and systems for managing network configurations are provided. Specifically, methods and systems are provided for improving QoS by prioritizing at the transaction level. The method may begin with receiving, at a gateway, an inbound or outbound transaction from a user device. The gateway may access and identify transaction identifiers associated with each transaction. A large language model (LLM) may categorize each type of transaction. Upon categorization of the transaction, a generative artificial intelligence (AI) may prioritize the transaction. Based on the priority level of the transaction, the transaction may be ranked against a plurality of transactions received at the gateway. Using the transaction ranking, the highest ranked transaction may be communicated first, then all other transactions received at the router may be communicated according to its transaction ranking, wherein the next highest ranked transaction is communicated and so on.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a network architecture for using an LLM and a generative AI to prioritize a transaction, in accordance with aspects herein;

FIG. 3 depicts a network architecture for using an LLM and a generative AI to rank a transaction, in accordance with aspects herein;

FIG. 4 depicts a flow diagram of an exemplary method for using an LLM and a generative AI to improve QoS by prioritizing at the transaction level, in accordance with aspects herein;

FIG. 5 depicts a flow diagram of yet another an exemplary method for using an LLM and a generative AI to improve QoS by prioritizing at the transaction level, in accordance with aspects herein; and

FIG. 6 depicts an exemplary computing device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
AMF Access & Mobility Management Function
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCF Policy Control Function
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SMF Session Management Function
SNR Transmission-to-noise ratio
SON Self-Organizing Networks
TDMA Time Division Multiple Access
TXRU Transceiver (or Transceiver Unit)
UDM Unified Data Management Function
UDR Unified Data Repository
UE User Equipment
UPF User Plane Function

Further, various technical terms are used throughout this description. An illustrative resource that fleshes out various aspects of these terms can be found in Newton's Telecom Dictionary, 32^{nd} Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

The present disclosure is directed to managing network configurations. In particular, systems and methods for improving QoS by prioritizing at the transaction level are described. According to aspects of the present disclosure, an in-flight transaction may be received at a gateway, such as a router, a network tower, a backhaul, or a load balancer. In other words, a gateway (e.g., a router, network tower, backhaul, load balancer, etc.) may receive an inbound or outbound transaction from a UE. The gateway may initially access and identify transaction identifiers (e.g., the transaction header and payload, the user profile, the application profile, transaction destination, etc.) associated with each transaction. Based on the transaction identifiers, a large language model (LLM) may categorize and/or label each type of transaction (e.g., such as critical, intermediate, or low). Upon categorization of the transaction, a generative artificial intelligence (AI) may prioritize the transaction, recognizing the content it receives and recommending a priority level for the in-flight transaction. Based on the priority level of the transaction, the transaction may be ranked (e.g., a highest ranking to a lowest ranking) against a plurality of transactions received at the gateway. Using the transaction ranking, the highest ranked transaction may be communicated first (e.g., reaches its destination before the other transactions), then all other transactions received at the router may be communicated according to corresponding transaction rankings, wherein the next highest ranked transaction is communicated and so on.

Accordingly, a first aspect of the present disclosure is directed to a system for improving QoS by prioritizing at the transaction level. The system comprises one or more processors and one or more computer-readable media storing computer-usable instructions that, when executed by the one or more processors, cause the one or more processors to: receive a transaction; identify one or more transaction identifiers associated with the transaction; determine, based on the one or more transaction identifiers, a transaction priority level of the transaction; upon determining the transaction priority level, rank the transaction against a plurality of transactions to generate a transaction ranking; and using the transaction ranking, communicate a highest ranked transaction at a first time prior to communicating the plurality of transactions.

A second aspect of the present disclosure is directed to a method for improving QoS by prioritizing at the transaction level. The method comprises: receiving a transaction; identifying one or more transaction identifiers associated with the transaction; determining, based on the one or more transaction identifiers, a transaction priority level of the transaction; upon determining the transaction priority level, ranking the transaction against a plurality of transactions to generate a transaction ranking; and using the transaction ranking, communicating a highest ranked transaction at a first time prior to communicating the plurality of transactions.

Another aspect of the present disclosure is directed to a method for improving QoS by prioritizing at the transaction level. The system comprises one or more processors and one or more non-transitory computer-readable media storing computer-usable instructions that, when executed by the one or more processors, cause the one or more processors to: receive a transaction; identify one or more transaction identifiers associated with the transaction; determine, based on the one or more transaction identifiers, a transaction priority level of the transaction; upon determining the transaction priority level, rank the transaction against a plurality of transactions to generate a transaction ranking for each of the plurality of transactions; and using the transaction ranking, communicate a highest ranked transaction at a first time prior to communicating the plurality of transactions.

As mentioned, the present disclosure describes improving QoS by prioritizing at the transaction level. Transactions may either be inbound or outbound transactions, but there are many different types of transactions. For example, inbound and outbound transactions may include types such as email, short message service (SMS), web surfing, video download, applications (e.g., social media, shopping, etc.), user control devices, device communications to other devices, application to application, and any other exchange of information between two or more parties over a communication network. This may involve various types of data, such as voice, text, or multimedia. A transaction begins when one party (e.g., a UE user) initiates a communication (e.g., sends an email, posts on social media, etc.). Data associated with the transaction may be transmitted over a network from an original endpoint to a destination endpoint.

However, an increase in network activity (e.g., an increase in sending and receiving transactions) in recent years has underscored the issue of network congestion and has negatively affected QoS within households as well as businesses. Network congestion occurs when a network, or a portion thereof, is overloaded with data, leading to a degradation in QoS. Network congestion typically happens when the volume of data being sent over the network exceeds the network's capacity to handle the volume of data efficiently. Network congestion is further compounded by the issue of applying uniform application of QoS across all devices using the network. For example, most network routers support a first come, first served approach to help user transactions flow though network routers and exit the local network to a destination, but a first come, first served approach does not appreciate the urgency warranted by some transactions.

In an attempt to solve the issue of network congestion, contemporary in-home routers facilitate QoS adjustments and assign higher priority routing to specific devices. In other words, conventional methods for dealing with network congestion include prioritizing specific devices that utilize a gateway (e.g., router). For example, an in-home router may facilitate QoS adjustments and assign a higher priority routing to a student living in the home. In this example, a designated UE (e.g., laptop) operated by the student may be assigned a higher priority than the other devices operating on the in-home router. Under such circumstances, this student's UE may be uniformly granted elevated priority across all transactions, potentially unnecessarily prioritizing certain transactions. Consequently, any outbound or inbound transaction sent or received on the student's UE, for example, may be prioritized and reach its destination before any other device using the in-home router. For instance, an email sent from the student's UE may reach its destination before a different user's search query inquiring about how to fix an actively leaking pipe reaches its destination (e.g., internet browser).

A similar scenario unfolds in business environments, where network congestion is a pervasive issue due to a higher user volume compared to home settings. In a business environment (e.g., an office setting), transaction types cover a broad spectrum encompassing internal office operations and external customer support. Additionally, an increase in customer call volumes during busy times of the year may result in a volume of data that can overwhelm the network. In severe cases of network congestion, the network might drop data packets, because the network cannot process them all, which may lead to information being lost or needing to be resent. In such cases, utilizing a first come, first served approach may lead to important transactions being lost. Furthermore, prioritizing at the device level in a business environment would be counterproductive, because each device handles tasks of varying urgency in a business environment. For instance, the urgency differs between customer care handling a live call (e.g., higher urgency) and an office worker processing offline customer transactions (e.g., lower urgency). Thus, to lessen the burden of network congestion, there is a need to improve QoS other than prioritizing specific devices.

The present solution seeks to improve QoS by prioritizing at the transaction level, by ranking transactions based on a priority level. Prioritizing at the transaction level may go beyond device-level prioritization, solving the issue of a device uniformly being granted elevated priority across all transactions, which bears the potential of unnecessarily prioritizing certain transactions. By categorizing priorities among in-transit transactions (i.e., transactions routing to a destination), more crucial transactions may be intelligently prioritized so that they may swiftly exit the network, allowing less critical transactions to follow suit. This approach introduces a type of smart traffic cop at a gateway (e.g., directing the flow of traffic that is received at a router), which may alleviate network congestion by addressing user issues in an efficient and rational order.

According to aspects of the present disclosure, a transaction (e.g., an inbound or outbound transaction) may be received at a gateway (e.g., a router, network tower, backhaul, load balancer, etc.), and the transaction may carry unique transaction identifiers associated with each transaction, which may be accessed and identified by the gateway. For example, the gateway may access the transaction header, transaction payload, user profile, application profile, date and time of the transaction, destination of the transaction, and any other information associated with the transaction (e.g., any transaction identifier). In some embodiments, the gateway may access these transaction identifiers, enabling the LLM to categorize the transaction type.

In implementations, based on at least one or more transaction identifiers, the LLM may inspect each transaction and categorize its type through labeling. In examples, the gateway may access the transaction identifiers (e.g., transaction header, transaction payload, user profile, application profile, date and time of the transaction, destination of the transaction, etc.), which may enable the LLM to categorize the transaction type. For example, the LLM may categorize transactions as a first type, a second type, a third type, and/or so on (e.g., any amount of categories and any type of transaction). For instance, transactions may be labeled as “critical,” “intermediate,” or “low.” Notably, these example labels of categories are for illustrative purposes, and any label may be generated by the LLM that captures a level within a hierarchy of priority.

In at least some examples, the generative AI may utilize the LLM's categorization output to generate priority recommendations and additional content for routing optimization. In other words, for example, the generative AI may adeptly set the appropriate priority level for each label, recognizing the content it receives and recommending the right priority for in-flight transactions. For example, transactions labeled as “critical” would warrant the highest priority level, which may allow such transactions to exit the network first. Continuing the example, the next priority level may be labeled as “intermediate,” and then the lowest level may be labeled as “low,” with each transaction falling into the “intermediate” category generally exiting the network before the transactions categorized as “low” priority. In this example, transactions labeled as “intermediate” and “low” may fall behind in a queue (e.g., the queue of transactions received by the gateway, waiting to be processed) to transactions labeled as “critical.”

In implementations, the gateway may prioritize and deliver transactions to their destination based on highest priority in the queue. For example, while highest-priority transactions reach their destination, lower-priority transactions are added to the queue in order of priority and received timestamp. In some examples, when processing in-flight transactions with assigned prioritization levels, the gateway may cross-check its waiting queue to determine if any higher-priority transaction could supersede a newly received transaction from the LLM and generative AI. For example, a transaction that has been waiting in the queue may receive a new higher-priority ranking based at least partially on its timestamp, and this new higher-ranking transaction may supersede a newly received transaction. In the absence of new transactions, for example, the router systematically processes its queue according to the priority list until the queue is empty. This method may ensure efficient and prioritized handling of network transactions. In other words, improving QoS according to the methods described herein may increase the efficiency of gateways by providing nuanced control over prioritizing individual transactions, thereby optimizing Wi-Fi traffic and mitigating congestion issues.

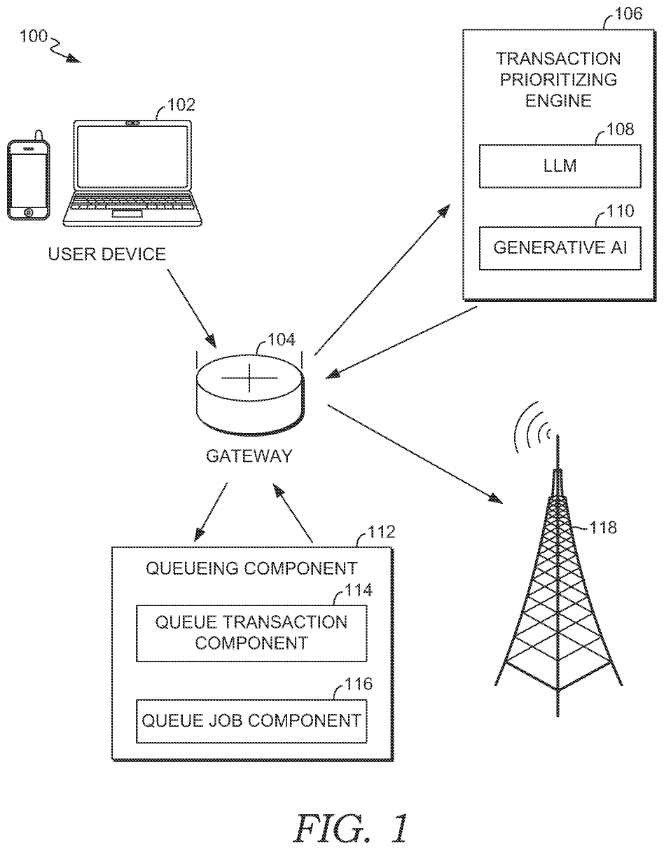

Referring now to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having dependency or requirement relating to any one or combination of components illustrated.

A network cell may comprise a gateway 104 (e.g., a router) to facilitate wireless communication between a communications device (e.g., user device 102) and a destination (e.g., base station 118). As shown in FIG. 1, the communications device may be the UE 102. The UE 102 may take on a variety of forms, such as a personal computer, a laptop computer (e.g., as depicted in FIG. 1), a tablet, a netbook, a mobile phone (e.g., as depicted in FIG. 1), a Smart phone, a personal digital assistant, or any other device capable of communicating with other devices. For example, the UE 102 may take on any form such as, for example, a mobile device or any other computing device capable of wirelessly communicating with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, the UE 102 is wirelessly connected or connected via a wired connection (e.g., such as an Ethernet cord) to the gateway 104 (e.g., a router). In this regard, the UE 102 may send or receive transactions, either wirelessly or wired, through the gateway 104.

In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, the network may be associated with a telecommunications provider that provides services to user devices, such as the UE 102. For example, the network may send and receive transactions to a provide services to user devices (e.g., such as the UE 102) or corresponding users that are registered or subscribed to utilize the services provided by a telecommunications provider.

In aspects, the UE 102 may send or receive transactions through the gateway 104 to communicate with other computing devices (e.g., a mobile device(s), a server(s), a personal computer(s), etc.). In examples, the gateway 104 serves as the point of entry for network requests, whether originating within the network or from the external internet. In implementations, whether the request (e.g., a transaction) is sent to the UE 102 or sent from the UE 102, both entry points in the gateway 104 (e.g., sending and receiving) are subject to the same prioritization rules as described herein.

In embodiments, the gateway 104 receives an in-flight transaction from the UE 102. In examples, the transaction arrives at the gateway 104 with transaction identifiers. For example, the gateway 104 may initially access and identify one or more transaction identifiers such as the user information, transaction header (e.g., containing high-level metadata about the user and transaction type), payload (e.g., containing the full content of the transaction), device information (e.g., IP address, model of device, etc.), user profile, application profile, transaction type, transaction date and time, transaction destination, and other types of information associated with each transaction. In embodiments, based on the transaction identifiers, the transaction is processed by the transaction prioritizing engine 106. In general, the transaction prioritizing engine 106 comprises an LLM 108 and a generative AI 110. In examples, the LLM 108 of the transaction prioritizing engine 106 may categorize and label each type of transaction (e.g., such as critical, intermediate, or low, for example). Furthermore, in embodiments, upon categorization of the transaction, the generative AI 110 of the transaction prioritizing engine 106 may prioritize the transaction, recognizing the content received and recommending a priority level for the in-flight transaction.

In aspects, the gateway 104 receives the priority level for the in-flight transaction from the transaction prioritizing engine 106. In examples, based on the priority level of the transaction, the transaction may be ranked by a queuing component 112 against a plurality of transactions received at the gateway 104 to generate a transaction ranking. In implementations, the queuing component 112 comprises a queue transaction component 114 and a queue job component 116. For example, the queue transaction component 114 of queuing component 112 may rank the transaction against a plurality of transactions received by gateway 104. In aspects, the queue job component 116 identifies the highest ranked transaction from the queue. Using the transaction ranking, for example, the highest ranked transaction may be communicated first (e.g., sent to the base station 118), then all other transactions received at the gateway 104 may be communicated sometime thereafter according to corresponding transaction rankings, wherein the next highest ranked transaction is communicated and so on.

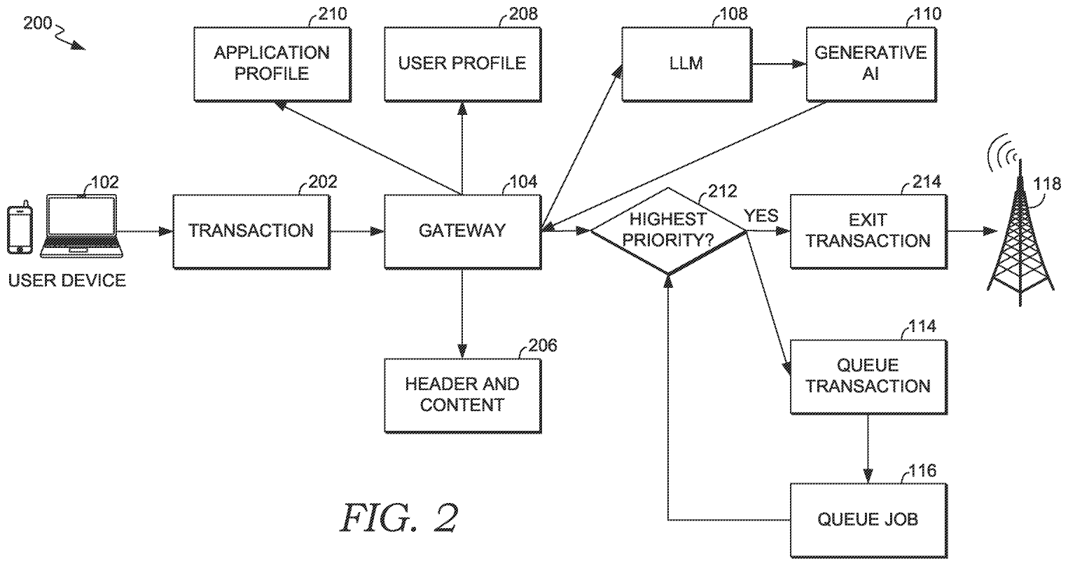

Turning to FIG. 2, FIG. 2 depicts a network architecture for using an LLM and a generative AI to prioritize a transaction, in accordance with aspects herein. In examples, the UE 102 may send a transaction 202 (e.g., any inbound or outbound transaction, which may include email, short SMS, web surfing, video download, applications, etc.) to the gateway 104. In embodiments, the gateway 104 will access transaction identifiers associated with the transaction 202, including, but not limited to, an application profile 210, a user profile 208, and a header & content 206.

For example, the header & content 206 may contain high-level metadata about the user (e.g., user identification, device information, etc.) and transaction type (e.g., website shopping, video leisure watching, security, urgent home improvement fixes, device notifications, etc.), as well as a body payload with the full content of the transaction (e.g., the data being transmitted as part of the transaction itself, including text messages (SMS, MMS), emails, voice calls, video calls, internet browsing, app data, file transfers, streaming services, etc.). In embodiments, the user profile 208 may comprise information that is essential for managing the network's relationship with the user and ensuring the efficient delivery of services, such information may include personal information (e.g., contact details), account details (e.g., information related to a user's account with a service provider), usage data (e.g., records of how the user interacts with services), billing and payment information, customer service interactions (e.g., call records, chat logs, email correspondence, etc.), security settings and permissions, and/or any other information that could be associated with a user profile. Furthermore, in examples, the application profile 210 may include contextual and behavioral information about the transaction 202, such as the status of the person involved with the transaction 202 (e.g., a care agent of a company handling a client matter with a client, internal office affairs between coworkers, etc.), the type of application being utilized (e.g., business applications, external applications such as social media, etc.), and the type of matter involved (e.g., customer handling, personal leisure, etc.).

In at least some embodiments, the transaction identifiers (e.g., the application profile 210, the user profile 208, and the header & content 206) accessed by the gateway 104 may be utilized by both the LLM 108 and the generative AI 110 of the transaction prioritizing engine 106 to categorize the transaction type. For example, the LLM 108 may utilize transaction identifiers to determine the user of the UE 102, the intent of the user of the UE 102 with the transaction 202, and the categorization of the transaction 202. In embodiments, based on the categorization of the transaction 202 by the LLM 108, the generative AI 110 may suggest a priority level (e.g., the next best action for the in-flight transaction) of the transaction 202 to determine its processing order in comparison to other transactions received by the gateway 104. The priority level recommendations derived from this disclosure may guide a network in delivering network requests (e.g., transactions) appropriately.

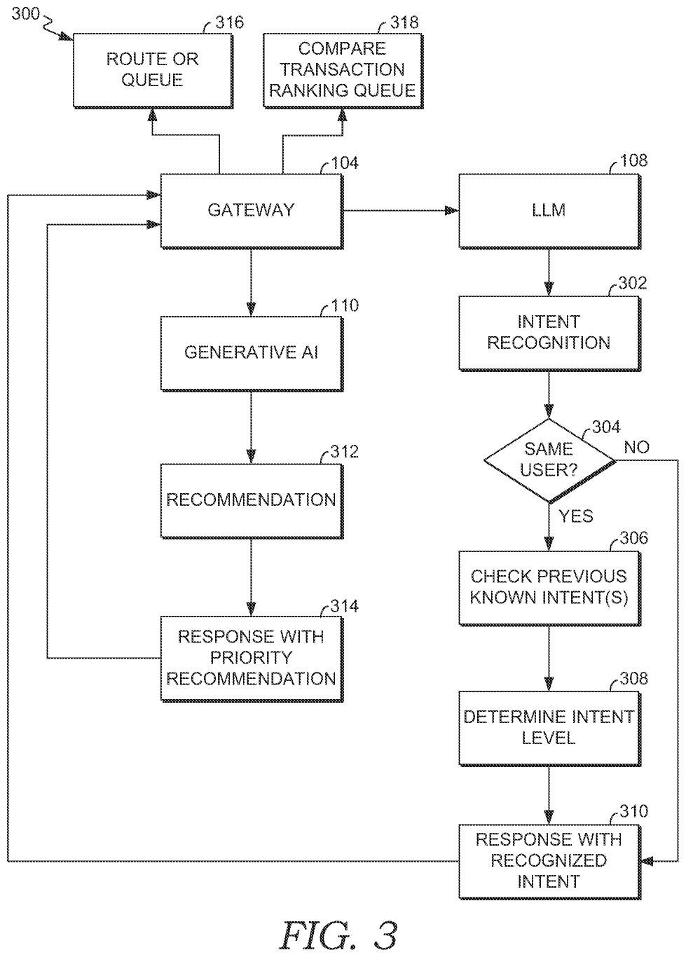

In examples, the gateway 104 may determine the transaction with a highest priority 212 (e.g., with the highest priority ranking) that may be communicated first (e.g., an exit transaction 214 to the base station 118 before other transactions waiting in the queue). In embodiments, utilizing the queuing component 112 of the transaction prioritizing engine 106 (e.g., not pictured in FIG. 2 for illustrative clarity), and based on the priority level of the transaction 202 received from the generative AI 110, the queue transaction component 114 may rank the transaction 202 against a plurality of transactions received by the gateway 104 (e.g., all of the other transactions being processed by the gateway 104). For example, the transaction 202 may involve a customer call while the plurality of transactions received by the gateway 104 may include sending an email, receiving a text message, web surfing, video downloading, utilizing functions of an application, and/or any other activity processed by the gateway 104. In other words, the queue transaction component 114 may, referring briefly now to FIG. 3 (e.g., via a compare transaction ranking with queue 318), compare the transaction ranking of the transaction 202 with the transaction rankings of the other transactions in the queue.

In implementations, based on the ranking of the transaction 202 (e.g., determined by the queue transaction component 114) as compared to the plurality of transactions received by the gateway 104, the queue job component 116 may identify the transaction with the highest priority 212 (e.g., the highest ranked transaction, which may or may not be the transaction 202). Using the transaction ranking, for example, the highest ranked transaction with the highest priority 212 may be communicated first (e.g., exit the network via the exit transaction 214) to a destination (e.g., the base station 118). In other words, referring briefly now to FIG. 3 (e.g., via a route or queue 316), and based on the ranking of the transaction 202, the queue job component 116 may either route the transaction 202 to its destination or keep the transaction 202 in the queue of the gateway 104, waiting to be processed. In examples, upon the highest ranked transaction (e.g., the transaction with the highest priority 212) leaving the network at the exit transaction 214 to the base station 118, all other transactions received at the gateway 104 may be processed and exit the network according to their corresponding transaction rankings, wherein the next highest ranked transaction with the highest priority 212 is processed and reaches its destination, continuing this way (e.g., processing the next highest ranked transaction with the highest priority 212) until the queue is empty.

Referring now to FIG. 3, FIG. 3 depicts a network architecture for using an LLM and a generative AI to rank a transaction, in accordance with aspects herein. In embodiments, the LLM 108 may utilize the transaction identifiers (e.g., referring briefly now to FIG. 2: the application profile 210, the user profile 208, and the header & content 206) accessed by the gateway 104 to categorize the transaction type. In embodiments, the LLM 108 includes several steps in categorizing a transaction, such as, but not limited to, recognizing the intent of a user, determining whether the user is a repeat user, checking a previous known intent of the repeat user, determining the current intent of the repeat user, and responding with a recognized intent of the repeat user. For example, the LLM 108 may include an intent recognition 302 to determine if the user is a same user 304, check a previous known intent(s) 306, determine an intent level 308, and provide a response with a recognized intent 310.

In examples, consideration of user knowledge and ongoing network requests may refine the accuracy of user intent, which may help determine a more accurate priority level for any given transaction. In embodiments, the intent recognition 302 may utilize the transaction identifiers associated with a transaction to determine the intent of the user in initializing the transaction. Furthermore, in implementations, the intent recognition 302 may determine if the user is the same user 304 (e.g., a repeat user) or an initial (e.g., first-time) user of the gateway 104. For example, an initial user's browsing request often involves further researching of a topic. In this example, the user's first browsing request would make the user an initial user, but any subsequent browsing requests (e.g., refining the search of a topic) would make the user the same user 304.

In embodiments, when the user is the same user 304 (e.g., a repeat user), the check previous known intent(s) 306 of the LLM 108 considers the purpose of previous transactions (e.g., transaction history, such as the browsing history of a research topic) in addition to other transaction identifiers before characterizing a transaction. For example, as the same user 304 becomes more specific in their browsing requests while researching a topic, the latter requests should be prioritized differently compared to other users' in-flight transactions. Continuing the example, if the latter requests are intended to pinpoint a method of solving an issue (e.g., a do-it-yourself home improvement topic, a medical issue, etc.), then that request should be characterized and prioritized differently (e.g., likely with a higher priority) than latter requests and/or in-flight transactions regarding leisurely topics (e.g., downloading a cartoon, browsing social media, etc.). In embodiments, previous known intent(s) and other transaction identifiers may be used by the determining intent level 308 of the LLM 108 to characterize the transaction. For example, a user's intent, as well as one or more transaction identifiers, may be saved as a user profile that may later be associated with the transaction. Maintaining a record of the user's profile and transaction history, which may be stored in computing device 600, may enhance transaction priority optimization. In examples, the characterization of the transaction is sent via the response with recognized intent 310 to the gateway 104.

In embodiments, when the user is not a repeat user (e.g., not the same user 304), the LLM 108 utilizes the transaction identifiers associated with a transaction to determine the intent of the user in initializing the transaction. For example, when user is not the same user 304, previous known intents are irrelevant (e.g., do not exist), but transaction identifiers may be utilized by the LLM 108 to characterize the transaction. In examples, the characterization of the transaction is sent via the response with recognized intent 310 to the gateway 104 for prioritization by the generative AI 110.

In implementations, the generative AI 110 utilizes the characterization of a transaction provided by the LLM 108, as well as the transaction identifiers, to provide a recommendation 312 regarding the priority level of the transaction. In other words, the recommendation 312 is the priority level of a transaction determined by the generative AI 110 based on the characterization of a transaction by the LLM 108 and the transaction identifiers associated with the transaction. In examples, the priority level of the transaction is sent via the response with priority recommendation 314 to the gateway 104.

Despite the recommendation 312 provided by the generative AI 110 regarding the priority level of a transaction, the transaction may nonetheless have a lower priority level than other transactions in the queue waiting to be processed by the gateway 104. Therefore, according to an embodiment of the present disclosure, a comparison (e.g., a ranking) between transactions (e.g., facilitated by the queueing component 112) is necessary in order to facilitate which transaction is first communicated (e.g., exits the network). In other words, when two transactions have different priority rankings, the highest ranked transaction is processed by the gateway 104 first. In examples, the compare transaction ranking with queue 318 (e.g., associated with the queue transaction component 114) may rank a transaction against a plurality of transactions to generate a transaction ranking and compare the transaction ranking of the transaction with the transaction rankings of the plurality of transactions in the queue. For example, based on the transaction ranking of the transaction, the route or queue 316 (e.g., associated with the queue job component 116) may either route the highest ranked transaction to its destination (e.g., communicate the transaction) or keep the transaction in the queue.

In implementations, the remaining transactions (e.g., those that were determined not to be the highest ranked transaction) may reenter the queue and receive a new transaction ranking based on the recommendation 312 and a timestamp of when the transaction was received by the gateway 104. In cases where two transactions share the same priority level, for example, a comparison of the timestamp of when the network received the transaction request may be determinative of which transaction is processed by the gateway 104 first (e.g., the transaction with the earlier timestamp is processed first, because it is the transaction with the highest priority level). Therefore, according to aspects of the present disclosure, a first come, first served strategy may be applied when the priority levels of transactions in the queue are the same.

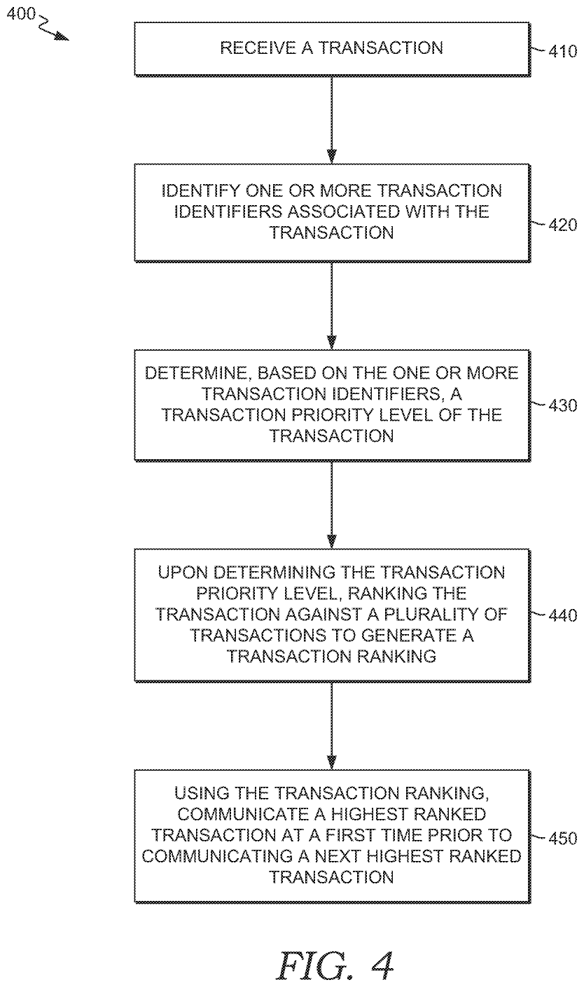

Turning to FIG. 4, a flow diagram 400 is provided illustrating a flow to prioritize transactions received by a gateway. Initially, at block 410, a transaction is received. One or more transaction identifiers associated with the transaction is identified at block 420. Transaction identifiers associated with the transaction may include a transaction header, transaction payload, user profile, application profile, date and time of the transaction, destination of the transaction, and any other information associated with the transaction. At block 430, based on the one or more transaction identifiers, a transaction priority level of the transaction is determined. Upon determining the transaction priority level, the transaction is ranked against a plurality of transactions to generate a transaction ranking at block 440. At block 450, using the transaction ranking, a highest ranked transaction is communicated at a first time prior to communicating a next highest ranked transaction.

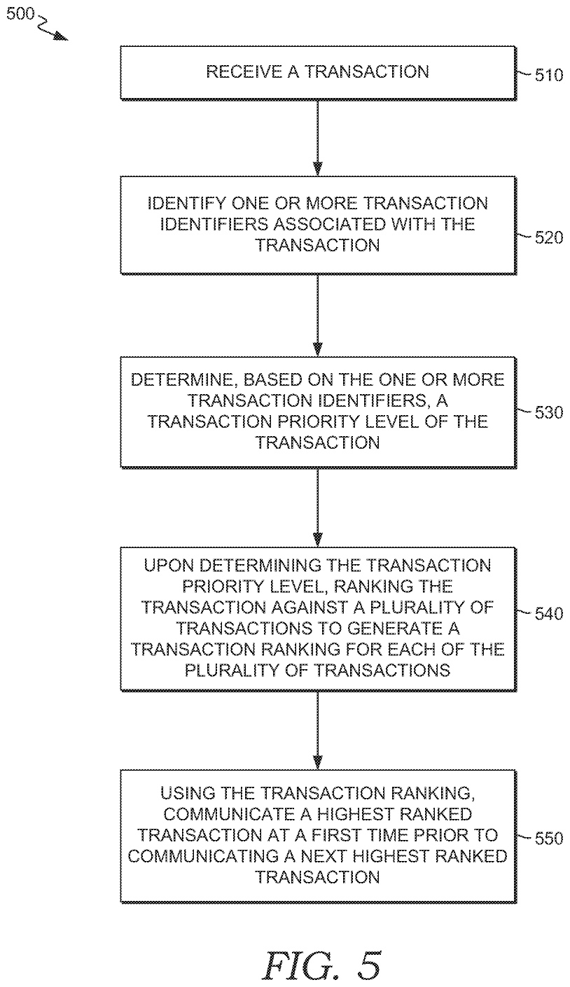

Referring to FIG. 5, a flow diagram 500 is provided illustrating a flow to prioritize transactions received by a gateway. Initially, at block 510, a transaction is received. One or more transaction identifiers associated with the transaction is identified at block 520. Transaction identifiers associated with the transaction may include a transaction header, transaction payload, user profile, application profile, date and time of the transaction, destination of the transaction, and any other information associated with the transaction. At block 530, based on the one or more transaction identifiers, a transaction priority level of the transaction is determined. Upon determining the transaction priority level, the transaction is ranked against a plurality of transactions to generate a transaction ranking for each of the plurality of transactions at block 540. At block 550, using the transaction ranking, a highest ranked transaction is communicated at a first time prior to communicating a next highest ranked transaction.

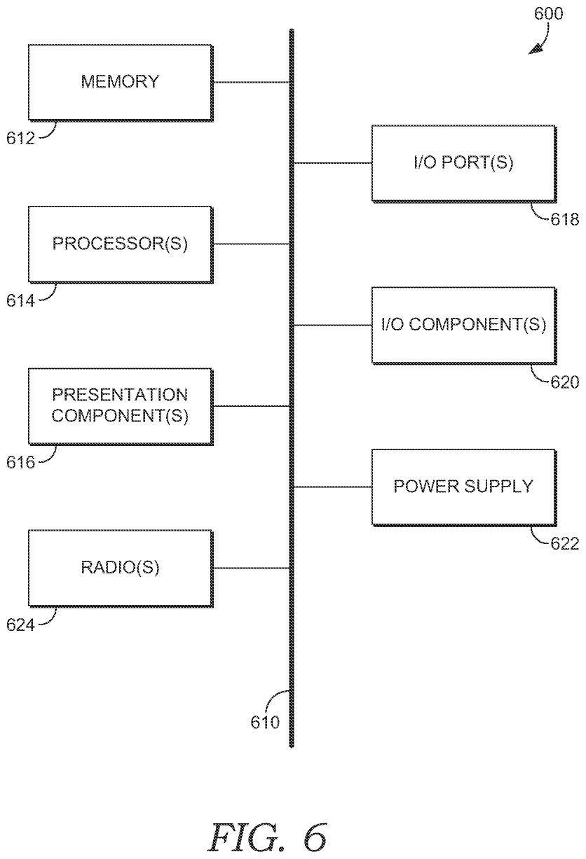

Referring to FIG. 6, a block diagram of an exemplary computing device 600 suitable for use in implementations of the technology described herein is provided. In particular, the exemplary computer environment is shown and designated generally as computing device 600. Computing device 600 is but one example of a suitable computing environment and is not intended to suggest any limitation as to the scope of use or functionality of the invention. Neither should computing device 600 be interpreted as having any dependency or requirement relating to any one or combination of components illustrated. It should be noted that although some components in FIG. 6 are shown in the singular, they may be plural. For example, the computing device 600 might include multiple processors or multiple radios. In aspects, the computing device 600 may be a UE/WCD, or other user device, capable of two-way wireless communications with an access point. Some non-limiting examples of the computing device 600 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 6, computing device 600 includes a bus 610 that directly or indirectly couples various components together, including memory 612, processor(s) 614, presentation component(s) 616 (if applicable), radio(s) 624, input/output (I/O) port(s) 618, input/output (I/O) component(s) 620, and power supply(s) 622. Although the components of FIG. 6 are shown with lines for the sake of clarity, in reality, delineating various components is not so clear, and metaphorically, the lines would more accurately be grey and fuzzy. For example, one may consider a presentation component such as a display device to be one of I/O components 620. Also, processors, such as one or more processors 614, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 612 may take the form of memory components described herein. Thus, further elaboration will not be provided here, but it should be noted that memory 612 may include any type of tangible medium that is capable of storing information, such as a database. A database may be any collection of records, data, and/or information. In one embodiment, memory 612 may include a set of embodied computer-executable instructions that, when executed, facilitate various functions or elements disclosed herein. These embodied instructions will variously be referred to as “instructions” or an “application” for short.

Processor 614 may actually be multiple processors that receive instructions and process them accordingly. Presentation component 616 may include a display, a speaker, and/or other components that may present information (e.g., a display, a screen, a lamp (LED), a graphical user interface (GUI), and/or even lighted keyboards) through visual, auditory, and/or other tactile cues.

Radio 624 represents a radio that facilitates communication with a wireless telecommunications network. Illustrative wireless telecommunications technologies include CDMA, GPRS, TDMA, GSM, and the like. Radio 624 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 624 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 618 may take a variety of forms. Exemplary I/O ports may include a USB jack, a stereo jack, an infrared port, a firewire port, other proprietary communications ports, and the like. Input/output (I/O) components 620 may comprise keyboards, microphones, speakers, touchscreens, and/or any other item usable to directly or indirectly input data into the computing device 600.

Power supply 622 may include batteries, fuel cells, and/or any other component that may act as a power source to supply power to the computing device 600 or to other network components, including through one or more electrical connections or couplings. Power supply 622 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A system for managing network configurations, the system comprising:
one or more processors; and
one or more computer-readable media storing computer-usable instructions that, when executed by the one or more processors, cause the one or more processors to:
receive a transaction;
identify one or more transaction identifiers associated with the transaction;
determine, based on the one or more transaction identifiers, a transaction priority level of the transaction;
upon determining the transaction priority level, rank the transaction against a plurality of transactions to generate a transaction ranking; and
using the transaction ranking, communicate a highest ranked transaction at a first time prior to communicating the plurality of transactions.

2. The system of claim 1, wherein the transaction is an inbound transaction or an outbound transaction.

3. The system of claim 1, wherein the transaction is received at a gateway, wherein the gateway comprises a router, a network tower, a backhaul, or a load balancer.

4. The system of claim 1, wherein the one or more transaction identifiers includes a device information, a user information, a transaction header, a transaction type, a transaction content, a transaction date and time, and a transaction destination.

5. The system of claim 4, wherein the one or more transaction identifiers is identified by a large language model.

6. The system of claim 1, wherein the transaction priority level of the transaction is determined by a generative artificial intelligence (AI), and wherein the gateway generates the transaction ranking.

7. The system of claim 1, wherein the one or more transaction identifiers is saved as a user profile that is associated with the transaction.

8. A method for managing network configurations, the method comprising:
receiving a transaction;
identifying one or more transaction identifiers associated with the transaction;
determining, based on the one or more transaction identifiers, a transaction priority level of the transaction;
upon determining the transaction priority level, ranking the transaction against a plurality of transactions to generate a transaction ranking; and
using the transaction ranking, communicating a highest ranked transaction at a first time prior to communicating the plurality of transactions.

9. The method of claim 7, wherein the transaction is an inbound transaction or an outbound transaction.

10. The method of claim 7, wherein the transaction is received at a gateway, wherein the gateway comprises a router, a network tower, a backhaul, or a load balancer.

11. The system of claim 7, wherein the one or more transaction identifiers includes a device information, a user information, a transaction header, a transaction type, a transaction content, a transaction date and time, and a transaction destination.

12. The system of claim 11, wherein the one or more transaction identifiers is identified by a large language model.

13. The system of claim 7, wherein the transaction priority level of the transaction is determined by a generative artificial intelligence (AI), and wherein the gateway generates the transaction ranking.

14. The system of claim 7, wherein the one or more transaction identifiers is saved as a user profile that is associated with the transaction.

15. A non-transitory computer storage media storing computer-usable instructions that, when used by one or more processors, cause the one or more processors to:
receive a transaction;
identify one or more transaction identifiers associated with the transaction;
determine, based on the one or more transaction identifiers, a transaction priority level of the transaction;
upon determining the transaction priority level, rank the transaction against a plurality of transactions to generate a transaction ranking for each of the plurality of transactions; and
using the transaction ranking, communicate a highest ranked transaction at a first time prior to communicating a next highest ranked transaction.

16. The non-transitory computer storage media of claim 15, wherein the transaction is an inbound transaction or an outbound transaction.

17. The non-transitory computer storage media of claim 15, wherein the transaction is received at a gateway, wherein the gateway comprises a router, a network tower, a backhaul, or a load balancer.

18. The non-transitory computer storage media of claim 15, wherein the one or more transaction identifiers includes a device information, a user information, a transaction header, a transaction type, a transaction content, a transaction date and time, and a transaction destination.

19. The non-transitory computer storage media of claim 18, wherein the one or more transaction identifiers is identified by a large language model.

20. The non-transitory computer storage media of claim 15, wherein the transaction priority level of the transaction is determined by a generative artificial intelligence (AI), and wherein the gateway generates the transaction ranking.
